(19) United States
(12) Patent Application Publication
(10) Pub. No.: US 2007/0067571 A1
(43) Pub. Date: Mar. 22, 2007

(54) Superior cache processor landing zone to support multiple processors

(76) Inventors: Claus Pribbernow, Munich (DE); David Parker, Minneapolis, MN (US)

Correspondence Address: Pete Scott, Senior Corporate Counsel;LSI Logic Corporation, Legal Department - IP, 1621 Barber Lane, MS D-106, Milpitas, CA, 95035, US

(21) Appl. No.: 11/231,276

(22) Filed: Sep. 19, 2005

(51) Int. Cl. G06F 13/28

(52) U.S. Cl. 711/123

(57) ABSTRACT

A data-processing system and method includes a group of memory components and a processor landing zone configured to include the memory components, wherein the memory components permit the processor landing zone to support both a single processor having a large instruction and data cache size and a plurality of processors having a small instruction and data cache size. The plurality of memory components can be provided as cache memory.

### TECHNICAL FIELD

Embodiments are generally related to data-processing methods, devices and systems. Embodiments are additionally related to cache memory, processor components and memory blocks associated with the design and construction of integrated circuits.

### BACKGROUND

Integrated circuits comprise many transistors and the electrical interconnections between them. Depending upon the interconnection topology, transistors perform Boolean logic functions like AND, OR, NOT, NOR and are referred to as gates. Some fundamental anatomy of an integrated circuit will be helpful for a full understanding of the factors affecting the flexibility and difficulty to design an integrated circuit. An integrated circuit comprises layers of a semiconductor, usually silicon, with specific areas and specific layers having different concentrations of electron and hole carriers and/or insulators. The electrical conductivity of the layers and of the distinct areas within the layers is determined by the concentration of ions referred to as dopants that are implanted into these areas. In turn, these distinct areas interact with one another to form the transistors, diodes, and other electronic devices.

These devices interact with each other by electromagnetic field interactions or by direct electrical interconnections. Openings or windows are created for electrical connections through the layers by an assortment of processing techniques including masking, layering, and etching additional materials on top of the wafers. These electrical interconnections may be within the semiconductor or may lie above the semiconductor areas using a complex mesh of conductive layers, usually of metal such as aluminum, tungsten, or copper fabricated by deposition on the surface and then selectively removed. Any of these semiconductor or connectivity layers may be separated by insulative layers, e.g., silicon dioxide.

Integrated circuits and chips have become increasingly complex with the speed and capacity of chips doubling about every eighteen months because of the continuous advances in design software, fabrication technology, semiconductor materials, and chip design. An increased density of transistors per square centimeter and faster clock speeds, however, make it increasingly difficult to design and manufacture a chip that performs as actually desired. Unanticipated and sometimes subtle interactions between the transistors and other electronic structures may adversely affect the performance of the circuit. These difficulties increase the expense and risk of designing and fabricating chips, especially those that are custom designed for a specific application. The demand for complex custom designed chips has increased along with the demand for applications and products incorporating microprocessors, yet the time and money required to design chips have become a bottleneck to bring these products to market. Without an assured successful outcome within a specified time, the risks have risen with the costs, and the result is that fewer organizations are willing to attempt the design and manufacture of custom chips.

One of the primary areas of interest in the design of integrated electronic systems is the field of cached processors and related memory blocks and components. Examples of cached processors include ARM (Advanced RISC Machines) and MIPS (Million Instructions Per Second) processors. Such cached processors can be implemented in the context of a core processor configuration. One example of such a core processor configuration is a processor core ware (CW) hard macro (HM). A hard macro (HM) is a complete physical implementation and addresses all requirements and design rules of the supported technology. Such a methodology has received wide acceptance in the integrated circuit industry, because implementation issues can be solved readily and the core ware (CW) integration at the chip level is predictable and can be executed efficiently. The hard macro implementation does not offer flexibility when it comes to supported cache size or processor specific configuration options. Thus, the often implemented processor hard macro is actually not a very good fit for typical customer requests.

One solution to these problems was the introduction of a flexible design for memory in integrated circuits, which has been referred to as a “landing zone” technology or concept, which results in the implementation of a cached processor. An example of this technology is disclosed in U.S. Patent Application Publication No. US 2005/0108495, entitled “Flexible Design for Memory Use in Integrated Circuits,” which published on May 19, 2005 and is assigned to LSI Logic Corporation of Milpitas, Calif., U.S.A. U.S. Patent Application Publication No. US 2005/0108495, which is incorporated herein by reference in its entirety, generally describes a method for designing and using a partially manufactured semiconductor product is disclosed.

As disclosed in U.S. Patent Application Publication No. US 2005/0108495, the partially manufactured semiconductor product, referred to as a slice, which contains a fabric of configurable transistors and one or more areas of embedded memory. The method contemplates that a range of processors, processing elements, processing circuits exists which might be manufactured as an hard macro or configured from the transistor fabric of the slice. The method then evaluates all the memory requirements of all the processors in the range to create a memory superset to be embedded into the slice. The memory superset can then be mapped and routed to a particular memory for one of the processors within the range; ports can be mapped and routed to access the selected portions of the memory superset. If any memory is not used, then it and/or its adjoining transistor fabric can become a “landing zone” for other functions or registers or memories.

Such technology can be thought of as one possible hard macro methodology, with the additional features of the hard macro constructed on an r-cell and the use of diffused memory resources of the slice. The metal hard macro with known timing characteristics that “snap” to a specific location and set of memories in a given slice as, for example, “integrator 1,” have been recognized by the integrated circuit industry as constituting an innovative concept. Thus, the technology disclosed in U.S. Patent Application Publication No. US 2005/0108495 can be utilized to enable a cached processor on an RC slice family “integrator 1” without the burden of developing processor specific slices.

Such “landing zone” technology, however, has several limitations, including reduced flexibility regarding processor type, the number of processors and the supported cache size. The “landing zone” concept supports only one processor hard macro implementation with a fixed cache size, while the demand from users and customers for multiple processor systems has increased, along with an increased demand for combinations of processor types and varying cache configurations. Additionally, the number of processor types that are supported by a particular slice configuration is fixed and determined at the time the slice is designed. This prohibits such landing zones from being used with a larger choice of processors. If other processor types are desired, more slice types with additional landing zones must be developed, which incurs additional development costs. Such landing zone technology also suffers from performance problems, and is not optimal for high performance applications. Finally, the hard macro implementation does not offer flexibility regarding supported cache sizes or processor specific configuration options, so that often the implemented processor hard macro is not a good fit for a specific customer or user request.

Based on the foregoing it is believed that an improved landing zone technology is necessary to increase flexibility and efficiency. It is believed that systems and methods disclosed here offer a solution to the problems inherent with current landing zone technology.

### BRIEF SUMMARY

The following summary of the invention is provided to facilitate an understanding of some of the innovative features unique to the present invention and is not intended to be a full description. A full appreciation of the various aspects of the invention can be gained by taking the entire specification, claims, drawings and abstract as a whole.

It is therefore one aspect of the present invention to provide for improved data-processing system and methods.

It is another aspect of the present invention to provide for an improved cache processor and cache processing system that supports multiple processors.

The above and other aspects of the invention can be achieved as will now be briefly described. A data-processing system and method are disclosed, which generally include a plurality of memory components and a processor landing zone configured to include the plurality of memory components, wherein the plurality of memory components permit the processor landing zone to support both a single processor having a large instruction and data cache size and a plurality of processors having a small instruction and data cache size. The plurality of memory components can be provided as cache memory.

Additionally, a slice is associated with the processor landing zone and the plurality of memory components. The memory components are generally provided as a superset of diffused memory instances located on the slice, thereby permitting the plurality of memory components to be accessible by the single processor and the plurality of processors while maintaining a maximum performance for implementations of both the single processor and the plurality of processors (i.e. multiple processor implementations). Additionally, the superset of diffused memory instances is based on a lowest common denominator configuration.

### BRIEF DESCRIPTION OF THE DRAWINGS

The accompanying figures, in which like reference numerals refer to identical or functionally similar elements throughout the separate views and which are incorporated in and form part of the specification, further illustrate embodiments of the present invention.

FIG. 1 illustrates a layout diagram of a system composed of a processor landing zone and associated components in accordance with a preferred embodiment;

FIG. 2 illustrates a layout diagram of a system that includes a processor landing zone and associated components in accordance with an alternative embodiment;

FIG. 3 illustrates a layout diagram of a system that includes a processor landing zone configuration based on a single processor core and a complete set of memories in accordance with another embodiment; and

FIG. 4 illustrates a layout diagram of a system that includes a processor landing zone configuration based on a four processor implementation using each one-quarter of a superset memory in accordance with an alternative embodiment.

### DETAILED DESCRIPTION OF THE INVENTION

The particular values and configurations discussed in these non-limiting examples can be varied and are cited merely to illustrate embodiments of the present invention and are not intended to limit the scope of the invention.

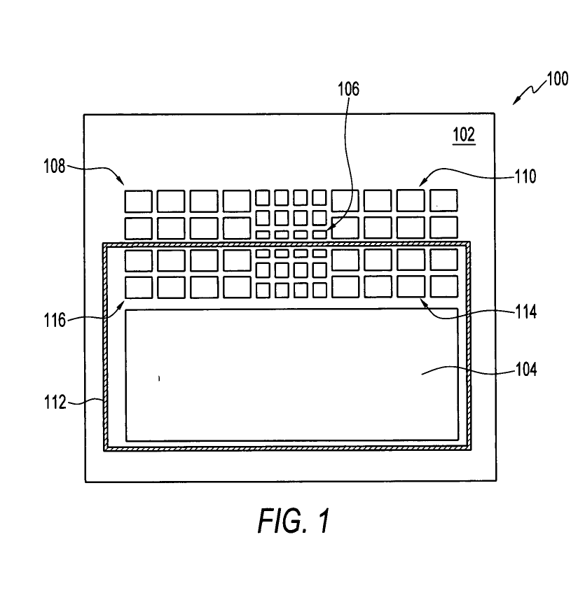

FIG. 1 illustrates a layout diagram of a system 100 composed of a processor landing zone 112 and associated components in accordance with a preferred embodiment. In general, system 100 includes a processor core 104, a plurality of memory components 108, 110 and 114, 116 and a slice 102. One example of a single memory component among memory components 108, 110 and 114, 116, is, for example, memory component 106. In general, the processor landing zone 112 is associated with processor core 104 and memory components 114, 116. Note that memory components 108, 110 and/or 114, 116 permit the processor landing zone 112 to support both a single processor having a large instruction and data cache size and multiple processors having a small instruction and data cache size, depending upon design considerations.

System 100 can be utilized to implement a set of memories, such as memory components 108, 110 and/or 114, 116, in the context of landing zone 102. Note that in general, the term “landing zone” as utilized herein refers to a processor landing zone, which can be implemented as a hard macro (HM) with known timing characteristics that snap to a specific location and a set of memories in a given base platform slice, such as, for example, slice 102 depicted in FIG. 1. System 100 is based on the selection of memory, the number of memory instances and memory architecture. Memory components 108, 110 and/or 114, 116 can form a superset of diffused memory instances, which are placed on a slice, such that a single and multiple processor cores, such as processor core 104, can access the memory set (i.e., memory components 108, 110 and/or 114, 116) and maintain the maximum performance for both types of implementation.

Cache memory instance numbers associated with memory components 108, 110 and 114, 116 are defined by the cache architecture. A four-way cache, for example, requires four memories per data set, along with four memories for a data tag, and four memories for an instruction set, and four memories for an instruction tag. Such a memory requirement is common between different types of four-way cached processor systems. The MIPS and PowerPC, for example, require additional two-way select memories, one for data and one for instruction. The ARM architecture, for example, requires only two valid memories and one “dirty” memory. This means that a set of 16, 2 or 16, 2, 1 memories is required to map a MIPS or a PowerPC processor to a set of memories. If one increases the cache size, the memory instances number will not increase, but the memory word depth will (e.g., from 512×32 to 1024×32). Different processor families generally possess different internal memory bus widths of, for example, 32 bits or 64 bits.

The superset of memories concept is based on the principle of the lowest common denominator. Instruction and data tag memories can be constructed on a 128×24 memory base. The instruction and data set can be built on a 512×36 memory base. The instruction and data paths, as well as the “dirty” and valid bit memories are generally constructed on a 128×10 memory base, depending upon design considerations. It can be appreciated, of course, that such values are merely suggested parameters and are not considered limiting features of the embodiments disclosed herein. All the memory instances in sum (e.g., 32*512×36 and 20*128×24) can be grouped together in one large block with a mirror horizontal x-axis. For dual implementation with the memory block, one processor may access the landing zone 102 from above while a second processor may access the landing zone 102 from below, again depending upon design considerations.

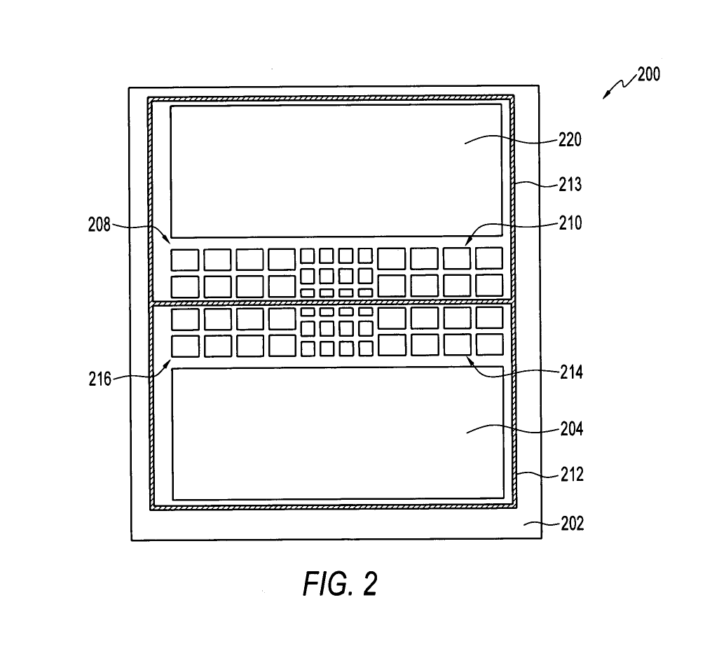

FIG. 2 illustrates a layout diagram of a system 200 that includes processor landing zones 212 and 213 and associated components in accordance with an alternative embodiment. In the embodiment depicted in FIG. 2, two processor cores 220 and 204 are illustrated, which are respectively associated with landing zones 213 and 212. A plurality of memory components 208, 210 are associated with landing zone 213 and processor core 220, while a plurality of memory components 216 and 214 are associated with landing zone 212 and processor core 204.

Processor core 204 can be implemented as, for example, an ARM926 Core R-Cell HM. Processor core 220 can also be implemented as an ARM926 Core R-Cell HM, depending upon design considerations. The configuration depicted in FIG. 2 can be referred to as a “superset landing zone” and can support up to 32 kB I and 32 kB D 4-way cache. System 200 can also support a dual 16 KB cache processor implementation via, for example, processor cores 220 and 204. System 200 additionally can support a combination of, for example, cached processor ARM 926 and/or Arm 966 TCM by way of example. System 200 can also support a 4 8 kbyte ARM926 processor arrangement depending upon design considerations.

In general, system 200 includes a plurality of memory components 208, 210 and 214, 216. The processor landing zones 213 and 212 are respectively configured to support memory components 208, 210 and 214, 216. Processor landing zones 213 and 212 can therefore support both a single processor having a large instruction and data cache size and a plurality of processors having a small instruction and data cache size. Slice 202 is therefore associated with the processor landing zones 213 and 212 and memory components 208, 210 and 214, 216. Such memory components 208, 210 and 214, 216 can function as a superset of diffused memory instances located on slice 202, thereby permitting the memory components 208, 210 and 214, 216 to be accessible by a single processor core and/or multiple processor cores, while maintaining maximum performance for implementations of both a single processor core and multiple processor cores.

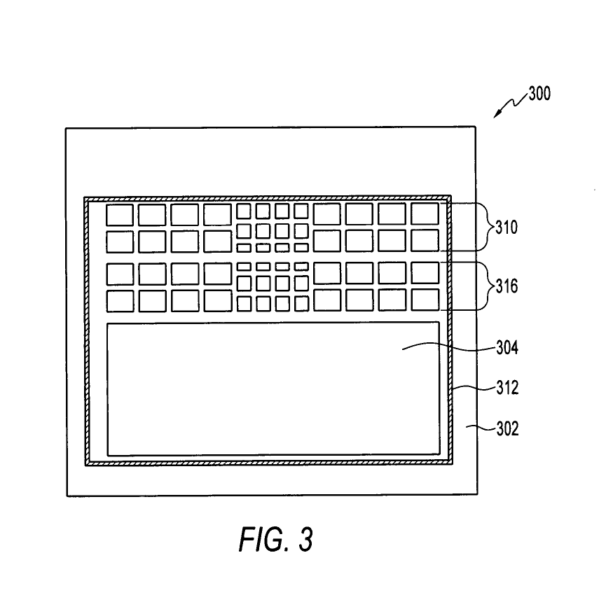

FIG. 3 illustrates a layout diagram of a system 300 that includes a processor landing zone configuration based on a single processor core 304 and a complete set of memories 310, 312 in accordance with another embodiment. FIG. 3 demonstrates the capability of supporting different cache sizes via a processor landing zone 312 in association with a slice 302. Note that slice 302 is similar to slice 202. Although a single processor core 304 is shown in FIG. 3, it can be appreciated that a complete set of memories 310, 312 (e.g., 32 KByte—4 way) can also be implemented.

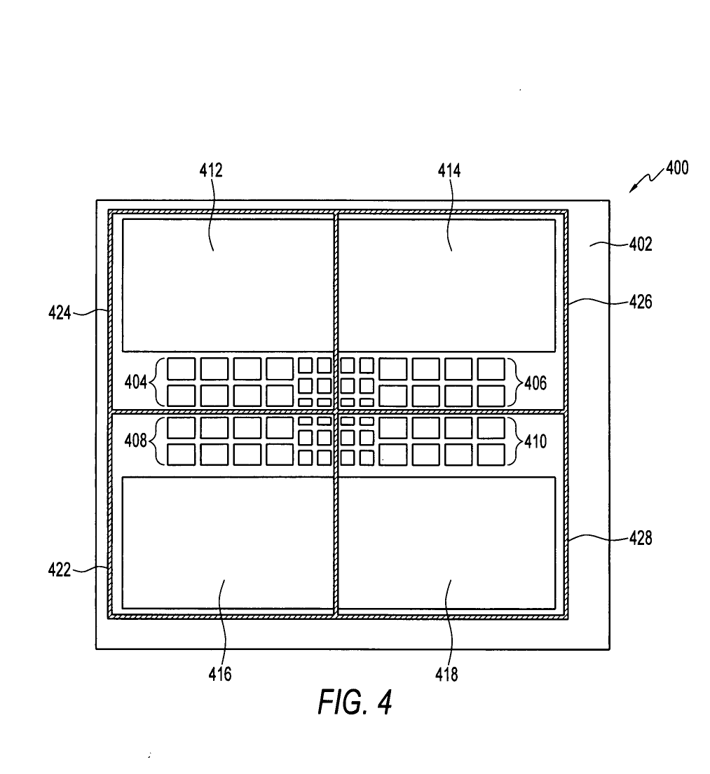

FIG. 4, on the other hand illustrates a layout diagram of a system 400 that includes a processor landing zone configuration based on a four processor implementation using each one-quarter of a superset memory in accordance with an alternative embodiment. System 400 generally includes four processor landing zones 422, 424, 426, and 428 in association with a slice 402. Processor landing zones 422, 424, 426, and 428 are respectively associated with memories 404, 406, 408 and 410 and processors 412, 414, 416, and 418. System 400 can be implemented in the context of, for example, an 8 KByte implementation with a maximum of 4 processors 412, 414, 416, 418 using each ¼ of the superset LZ memories (x, y axis symmetrical cut).

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A data-processing system, comprising:
a plurality of memory components; and
a processor landing zone configured to include said plurality of memory components, wherein said plurality of memory components permit said processor landing zone to support both a single processor having a large instruction and data cache size and a plurality of processors having a small instruction and data cache size.

2. The system of claim 1 wherein said plurality of memory components comprises at least one cache memory.

3. The system of claim 1 further comprising at least one slice associated with said processor landing zone and said plurality of memory components.

4. The system of claim 3 wherein said plurality of memory components comprises a superset of diffused memory instances located on said at least one slice, thereby permitting said plurality of memory components to be accessible by said single processor and said plurality of processors while maintaining a maximum performance for implementations of both said single processor and said plurality of processors.

5. The system of claim 4 wherein said superset of diffused memory instances is based on a lowest common denominator configuration.

6. The system of claim 1 wherein said plurality of memory components comprises at least one instruction tag and at least one data tag.

7. The system of claim 6 wherein said at least one instruction tag and at least one data tag are configured on a memory base.

8. The system of claim 1 wherein said single processor having a large instruction and data cache size and said plurality of processors having a small instruction and data cache size are configured on a metal hard macro.

9. A data-processing system, comprising:
a plurality of memory components; and
a processor landing zone configured to include said plurality of memory components, wherein said plurality of memory components permit said processor landing zone to support both a single processor having a large instruction and data cache size and a plurality of processors having a small instruction and data cache size; and
at least one slice associated with said processor landing zone and said plurality of memory components, wherein said plurality of memory components comprises a superset of diffused memory instances located on said at least one slice, wherein said plurality of memory components comprises a superset of diffused memory instances located on said at least one slice, thereby permitting said plurality of memory components to be accessible by said single processor and said plurality of processors while maintaining a maximum performance for implementations of both said single processor and said plurality of processors.

10. The system of claim 9 wherein said superset of diffused memory instances is based on a lowest common denominator configuration.

11. The system of claim 9 wherein said plurality of memory components comprises at least one instruction tag and at least one data tag.

12. The system of claim 11 wherein said at least one instruction tag and at least one data tag are configured on a memory base.

13. The system of claim 9 wherein said single processor having a large instruction and data cache size and said plurality of processors having a small instruction and data cache size are configured on a metal hard macro.

14. A data-processing method, comprising:
providing a plurality of memory components; and
configuring a processor landing zone to include said plurality of memory components, wherein said plurality of memory components permit said processor landing zone to support both a single processor having a large instruction and data cache size and a plurality of processors having a small instruction and data cache size.

15. The system of claim 14 further comprising configuring said plurality of memory components to comprise at least one cache memory.

16. The system of claim 14 further comprising association at least one slice with said processor landing zone and said plurality of memory components.

17. The method of claim 16 further comprising configuring said plurality of memory components to comprise a superset of diffused memory instances located on said at least one slice, thereby permitting said plurality of memory components to be accessible by said single processor and said plurality of processors while maintaining a maximum performance for implementations of both said single processor and said plurality of processors.

18. The method of claim 17 further comprising configuring said superset of diffused memory instances based on a lowest common denominator configuration.

19. The method of claim 14 further comprising configuring said plurality of memory components to comprise at least one instruction tag and at least one data tag.

20. The method of claim 19 further comprising configuring said at least one instruction tag and at least one data tag on a memory base.

21. The method of claim 14 further comprising configuring said single processor having a large instruction and data cache size and said plurality of processors having a small instruction and data cache size to comprise a metal hard macro.
